(19) United States
(12) Patent Application Publication
(10) Pub. No.: US 2022/0255255 A1
(43) Pub. Date: Aug. 11, 2022

(54) SOCKET, METHOD FOR PRODUCING SAME, AND PLUG CONNECTOR

(71) Applicant: STÄUBLIEL ECTRICAL CONNECTORS AG, Allschwil (CH)

(72) Inventors: Tom KUFNER, Riehen (CH); Philipp Alexander STREHLER, Basel (CH); Lucas WIRZ-VITIUK, Basel (CH)

(73) Assignee: STÄUBLIEL ECTRICAL CONNECTORS AG, Allschwil (CH)

(21) Appl. No.: 17/617,834

(22) PCT Filed: Jun. 8, 2020
(86) PCT No.: PCT/EP2020/065767

§ 371 Date: Dec. 9, 2021

(30) Foreign Application Priority Data
Jun. 11, 2019 (EP) 19179379.3

(51) Int. Cl. H01R 13/187; H01R 43/18; H01R 13/11

(52) U.S. Cl. CPC H01R 13/187; H01R 13/111; H01R 43/18

(57) ABSTRACT

A socket for connection to a plug comprises a socket housing with a socket wall and a contact element. The contact element has a contact region which is designed to form a functional contact with the plug. The contact element has, at least in regions, at least one elastic contact section which is designed in such a way that, when the plug is received in a contact element opening of the contact element, it expands radially with respect to a longitudinal direction (L). The socket wall has on the inside a limiting element which is designed in such a way that a radial expansion of the elastic contact section of the contact element is limited, the limiting element being in particular in the region of the contact region of the contact element.

### TECHNICAL FIELD

The present invention relates to a socket for connecting to a plug according to claim 1, a plug connector comprising such a socket and a plug according to claim 14, and a method of manufacturing a socket according to claim 15.

### PRIOR ART

Plug connectors comprising a socket with a contact element and a plug are used in a variety of applications to enable a generally electrical connection between components. The contact elements are intended to ensure a reliable connection between the plug and the socket.

From U.S. Pat. No. 5,730,628 a socket with a stop element is known, wherein the stop element serves as a limitation for the transverse movement of the contact element mounted in the socket when mating with a plug. This is to prevent the contact element from exceeding its elastic limit. However, if the plug is not inserted optimally in the process, but for example at an angle into the socket, deformation of the contact element may still occur. As a result, contact between the plug and the socket is impaired or even impossible.

### SUMMARY OF THE INVENTION

It is therefore an object of the present invention to provide a socket for connection to a plug, which socket provides an improved and secure connection to a plug.

This object is solved by a socket according to claim 1. In particular, a socket for connecting to a plug is provided, comprising a socket housing having a proximal housing end, a distal housing end and a socket wall, and a contact element having a proximal contact element end and a distal contact element end. The socket wall defines a socket opening in which the contact element is receivable. The contact element has a contact region configured to form a functional contact, in particular an electrical contact, with the plug. The contact element delimits a contact element opening into which the plug is receivable. The contact element has, at least in regions, at least one elastic contact section, the elastic contact section being designed in such a way that, when the plug is received in the contact element opening of the contact element of the socket, it expands radially with respect to a longitudinal direction extending centrally through the socket. The elastic contact section is thus radially expandable when a plug is inserted into its contact element opening. For this purpose, it is thus preferred if the socket is designed for connection to a plug, wherein a diameter or clear width of the contact element opening in the unconnected state of the plug, at least in the region of the elastic contact section, is smaller than a diameter or cross-section of the plug at least in a plug region which is connected to the socket. The plug region is preferably inserted into the contact element opening when the plug is connected to the socket. The socket wall has, on the inside, a limiting element which is designed in such a way as to limit a radial expansion of the elastic contact section of the contact element, the limiting element being arranged in particular in the region of the contact region of the contact element.

Due to the fact that the limiting element not only limits a radial expansion of the contact element, but is also arranged in particular in the region of the contact region of the contact element, the radial expansion of the contact section can be limited by the limiting element irrespective of an insertion direction of the plug into the contact element opening. As a consequence, plastic deformation of the contact element is prevented even in the case of, for example, an obliquely inserted plug, thus ensuring an improved and secure connection between the socket and the plug.

The socket can be a one-piece socket. However, a multi-part socket, for example a two-part socket, is equally conceivable. For example, the socket housing may comprise two or more socket housing parts which may be joined together to form a socket. The connection between the two socket housing parts may be formed in a releasable or non-releasable manner. For example, a connection can be achieved by a force fit and/or a form fit and/or by pressing, gluing, welding, etc. of the socket housing parts. In this case, a connection is preferably achieved by means of connecting elements on the respective socket housing parts which are appropriately formed with respect to one another. For example, a first socket housing part can have a first connecting element, which first connecting element can be connected to a second connecting element on the second socket housing part. A wide variety of configurations of the connecting elements are conceivable. For example, the first connecting element could be a recess formed on the inside of the socket wall, which can be connected to a second connecting element in the form of a recess formed on the outside of the socket wall.

Preferably, the limiting element is configured to prevent plastic deformation of the elastic contact section of the contact element of the socket when the plug is received in the contact element opening of the contact element of the socket. In other words, the limiting element allows elastic, i.e. reversible, deformation of the elastic contact section, but at the same time prevents plastic, i.e. irreversible, deformation of the elastic contact section.

The limiting element is preferably arranged and formed such that it provides a guide for the plug when it is received in the contact element opening along a connection direction. Thus, the limiting element may also serve as a guide element. The provision of separate guide elements is not required, whereby the plug-in depth of the socket can be reduced and, in the case of a plug connected to the socket, a compact plug connector can be obtained. For this reason in particular, it is preferred that the limiting element is arranged in the region of the distal end of the housing.

The limiting element, as seen in cross-section with respect to the socket wall, may be formed at least regionally as at least one elevation and the elastic contact section, as seen in cross-section, may define at least regionally at least one recess, the elevation and the recess being formed substantially complementary to each other.

If the plug is now inserted into the socket, the plug increasingly presses the elastic contact section of the contact element radially outwards in the direction of the socket wall. In the process, the at least one recess of the elastic contact section is increasingly pressed in the direction of the at least one elevation of the limiting element and, if the radial expansion is sufficiently large, strikes against the elevation of the limiting element. This limitation is ensured due to the complementarily formed structures, regardless of the direction of insertion of the plug into the socket.

Preferably, in the case of a plug received in the contact element opening, the elevation is substantially completely receivable in the recess of the elastic contact section, wherein in particular at least regionally a surface contact is formed between the elastic contact section defining the recess and the elevation of the socket wall.

The elastic contact section is preferably biased at least regionally increasingly inwardly in the direction of the longitudinal direction when viewed from the proximal contact element end towards the distal contact element end, and/or the limiting element preferably extends at least regionally and preferably increasingly inwardly in the direction of the longitudinal direction when viewed from the proximal housing end towards the distal housing end.

The inwardly biased elastic contact section and a non-inwardly biased region of the contact element of the socket may include a first angle of from about 10° to 50°, preferably from about 15° to 45°, more preferably from about 20° to 40°, in the absence of the plug in the contact element opening. Moreover, or alternatively, in the case of a plug received in the contact element opening, the inwardly biased elastic contact section and the non-inwardly biased portion of the contact element of the socket may include a second angle of from about 5° to 45°, preferably from about 5° to 40°, more preferably from about 5° to 35°, most preferably from about 11°.

That is, the elastic contact section may be biased inwardly in the direction of the longitudinal direction such that it forms a first angle with an unbiased portion of the contact element in the above-mentioned range in the absence of a plug and a second angle in the above-mentioned range in the presence of a plug. Due to the configuration for radial expansion, the first angle is preferably larger than the second angle. Or, in other words, the elastic contact section is more inwardly biased in the socket in the absence of the plug than in the presence of the plug.

A diameter of the socket opening in the region of the limiting element is preferably smaller than a diameter in a region of the socket opening adjoining this region and facing the proximal housing end. Or, in other words, a recess is formed in the socket wall proximally of the limiting element. This embodiment has the advantage that a part of the elastic contact section of the contact element can be protruded into the recess when a plug is received in the contact element opening. Preferably, the recess is such that a part of the elastic contact section projecting into the recess is only elastically deformed, but not plastically deformed.

Preferably, the limiting element extends at least partially, in particular completely along a circumferential direction of the socket wall, in particular of the socket opening. In other words, the limiting element can be provided on the inside of the socket wall, viewed in the circumferential direction, only over a partial region or in segments, but also completely.

The limiting element, viewed along the longitudinal direction, preferably extends substantially completely along the elastic contact section of the contact element of the socket.

The socket wall may have an end section in the region of the distal housing end in which the socket opening has a diameter which is larger than a diameter in the region of the proximal housing end, and the elastic contact section may have an end section in the region of the distal contact element end which extends radially outwardly with respect to the longitudinal direction, so that, in the case of a plug received in the contact element opening, a stop is formed between the end sections, which preferably prevents displacement of the contact element relative to the socket housing along a proximal direction extending from the distal housing end towards the proximal housing end. Alternatively, however, it is also conceivable that the socket wall in the region of the distal housing end has an end section in which the socket opening has a diameter which is smaller than a diameter in the region of the proximal housing end. In addition, it is conceivable to provide a stop by means of recesses in the socket wall and correspondingly formed projections on the contact element, see further below.

That is, the contact element preferably has an elastic contact section which, starting from the proximal contact element end as viewed in the direction of the distal contact element end, is initially biased inwardly in the direction of the longitudinal direction and then, however, extends radially outwardly away from the longitudinal direction. It is further the case that, starting from the proximal housing end and viewed in the direction of the distal housing end, the socket wall initially extends inwardly in the direction of the longitudinal direction due to the limiting element and then, however, preferably increasingly extends radially outwardly and terminates in an end section which is radially widened with respect to the longitudinal direction. Preferably, the socket wall and the contact element are formed complementary to each other only in sections or over the entire range just mentioned.

The socket wall may have one or more recesses in the region of the proximal end of the housing, and the contact element may have one or more projections in the region of the proximal end of the contact element which are receivable in the recesses, thereby preventing displacement of the contact element relative to the socket housing along a distal direction extending from the proximal end of the housing towards the distal end of the housing. As previously mentioned, the recesses in the socket wall also provide a stop for the projections on the contact element, limiting unwanted displacement of the contact element relative to the socket housing along a proximal direction extending from the distal housing end toward the proximal housing end. Preferably, the recesses and the protrusions provide a snap or latch connection. Preferably, a plurality of recesses and protrusions are provided which are provided along a circumferential direction of the socket opening and along a circumferential direction of the contact element, respectively.

The contact element can have one or more contact points projecting radially outwards, which are arranged on the outside of the contact element and can be brought into contact with the inside socket wall, it being possible to establish a connection, in particular an electrical connection, between the contact element and the socket. Via these contact points, a contact established between the elastic contact section and the plug can be passed on to the socket.

The above-mentioned recess for partially receiving the elastic contact section is preferably formed between the region of the inner-side socket wall, which can be brought into contact with the contact points, and the limiting element.

Preferably, the elastic contact section is provided by two or more elastic spring arms each terminating in free ends in the region of the distal contact element end, the free ends preferably being offset radially outwardly with respect to the longitudinal direction.

Particularly preferably, the elastic contact section is formed by a plurality of elastic spring arms arranged around a longitudinal axis of the contact element and separated from each other by gaps or slots between adjacent spring arms. The spring arms extend from the proximal contact element end as viewed towards the distal contact element end, first increasingly inwardly in the direction of the longitudinal direction and then increasingly outwardly. The contact points projecting from the contact element are preferably arranged in the elastic region of the spring arms and act as a pivot point for the spring arms during their radial expansion. At the same time, the contact points provide a defined contact point for the socket wall. The arrangement of the contact points on the contact element thus influences the spring property of the spring arms. Or, in other words, a displacement of the contact points leads to different spring properties of the spring arms.

In a further aspect, a plug connector comprising a socket as described above and a plug is disclosed, wherein the plug is received in the contact element opening of the contact element of the socket and radially expands the elastic contact section with respect to the longitudinal direction, and wherein the radial expansion of the elastic contact section is limited by the limiting element. Thus, it is preferred if a diameter or clear width of the contact element opening in the unconnected state of the plug at least in the region of the elastic contact section is smaller than a diameter or cross-section of the plug at least in the region of its insertion into the contact element.

As mentioned at the beginning, the limiting element limits a radial expansion of the contact element through the plug regardless of its insertion direction or insertion position.

In another aspect, a method of manufacturing a socket, in particular a socket as described above, for connection to a plug is provided, the method comprising the steps of: Providing a socket housing having a socket wall, the socket wall defining a socket opening; providing a contact element; and inserting the contact element into the socket opening. The contact element has a contact region configured to form a functional contact, in particular an electrical contact, with the plug, and the contact element delimits a contact element opening into which the plug is receivable. The contact element has, at least in some regions, at least one elastic contact section, the elastic contact section being designed in such a way that, when the plug is received in the contact element opening of the contact element of the socket, it expands radially with respect to a longitudinal direction extending centrally through the socket. The socket wall has on the inside a limiting element which is designed in such a way that a radial expansion of the elastic contact section of the contact element is limited, the limiting element being arranged in particular in the region of the contact region of the contact element.

### BRIEF DESCRIPTION OF THE DRAWINGS

Preferred embodiments of the invention are described below with reference to the drawings, which are for explanatory purposes only and are not to be construed in a limiting manner. In the drawings show:

FIG. 1 shows a central longitudinal section through a socket comprising a socket housing and a contact element in a first state;

FIG. 2 shows a central longitudinal section through the socket according to FIG. 1 in a second state;

FIG. 3a shows a central longitudinal section through a socket housing of a simplified socket;

FIG. 3b shows a central longitudinal section through the socket housing and through a contact element of the simplified socket shown in FIG. 3a in a first state;

FIG. 3c shows a central longitudinal section through the socket housing and the contact element of the simplified socket shown in FIG. 3a in a second state;

FIG. 4 shows a top view of a contact element in a first state;

FIG. 5 shows a perspective view of the contact element according to FIG. 4 in a second state;

FIG. 6 shows a central longitudinal section through the contact element according to FIG. 5;

FIG. 7 shows a perspective view of a contact element according to a further embodiment;

FIG. 8 shows a side view of the contact element according to FIG. 7;

FIG. 9 shows a front view of the contact element according to FIG. 7;

FIG. 10 shows a perspective view of a contact element according to a further embodiment;

FIG. 11 shows a side view of the contact element according to FIG. 10;

FIG. 12 shows a front view of the contact element according to FIG. 10;

FIG. 13 shows a perspective view of a contact element according to a further embodiment;

FIG. 14 shows a side view of the contact element according to FIG. 13;

FIG. 15 shows a front view of the contact element according to FIG. 13;

FIG. 16 shows a perspective view of a socket housing according to a further embodiment;

FIG. 17 shows a front view of the socket housing according to FIG. 16;

FIG. 18 shows a central longitudinal section through the socket housing according to FIG. 16;

FIG. 19 shows a perspective view of a socket housing according to a further embodiment;

FIG. 20 shows a front view of the socket housing according to FIG. 19;

FIG. 21 shows a central longitudinal section through the socket housing according to FIG. 19;

FIG. 22 shows a perspective view of a socket comprising the contact element according to FIG. 7 and the socket housing according to FIG. 16;

FIG. 23 shows a front view of the socket according to FIG. 22;

FIG. 24 shows a central longitudinal section through the socket according to FIG. 22;

FIG. 25 shows a perspective view of a socket comprising the contact element according to FIG. 10 and the socket housing according to FIG. 19;

FIG. 26 shows a front view of the socket according to FIG. 25;

FIG. 27 shows a central longitudinal section through the socket according to FIG. 25;

FIG. 28 shows a perspective view of a socket according to a further embodiment having a first socket housing portion and a second socket housing portion in an unconnected state;

FIG. 29 shows a side view of the socket according to FIG. 28;

FIG. 30 shows a central longitudinal section through the socket according to FIG. 28;

FIG. 31 shows a perspective view of the socket shown in FIG. 28 with the first socket housing portion and the second socket housing portion in the connected state;

FIG. 32 shows a front view of the socket according to FIG. 31;

FIG. 33 shows a side view of the socket according to FIG. 31;

FIG. 34 shows a central longitudinal section through the socket according to FIG. 31;

FIG. 35 shows a perspective view of the socket according to FIG. 31 comprising the contact element according to FIG. 7;

FIG. 36 shows a front view of the socket comprising the contact element according to FIG. 35;

FIG. 37 shows a central longitudinal section through the socket comprising the contact element according to FIG. 35.

### DESCRIPTION OF PREFERRED EMBODIMENTS

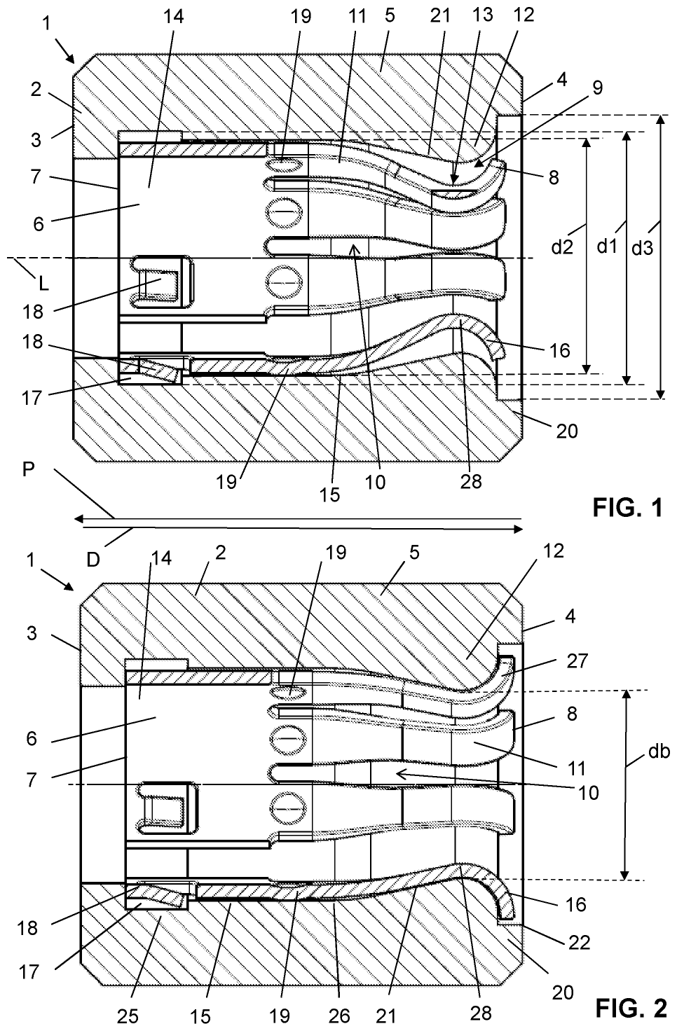

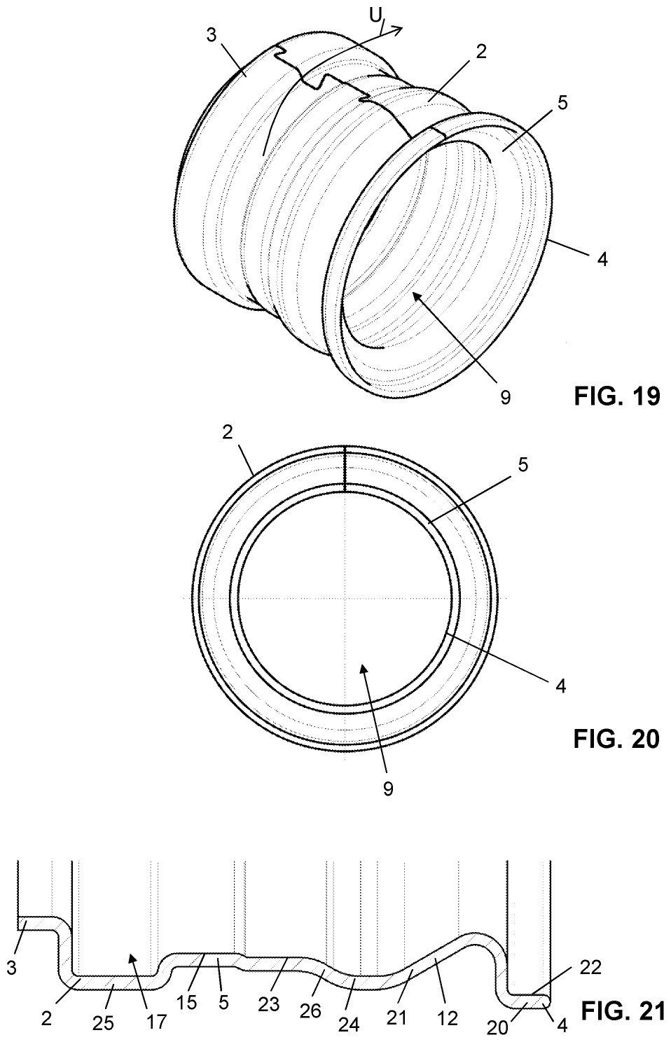

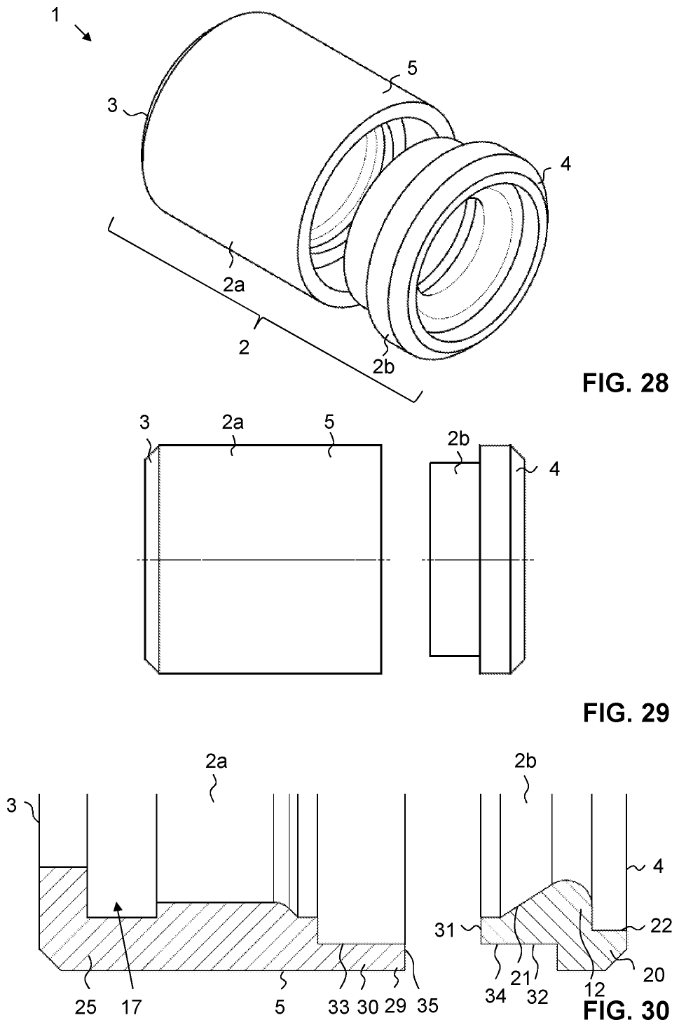

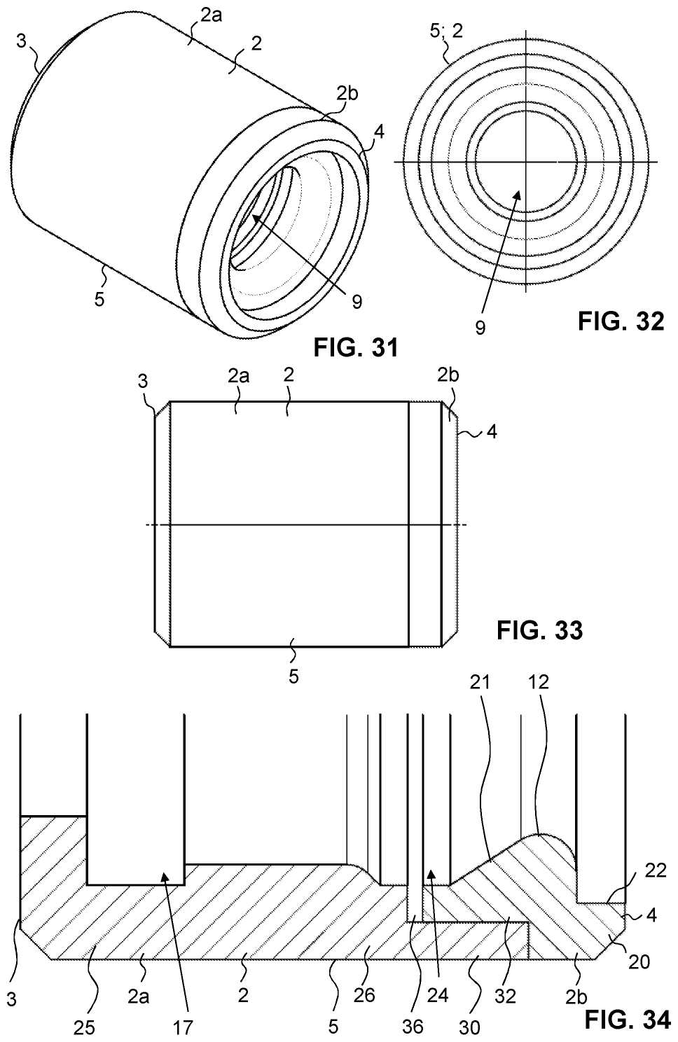

FIGS. 1 to 37 illustrate various aspects of a socket 1 according to the invention, which can be connected to a plug to form a plug connector. In all embodiments, the socket 1 comprises a substantially cylindrical socket housing 2 having a proximal housing end 3, a distal housing end 4 and a socket wall 5. FIGS. 1 to 27 differ from FIGS. 28 to 37 in that the socket 1 according to FIGS. 1 to 27 is formed with a one-piece socket housing 2, whereas the socket housing 2 according to FIGS. 28 to 37 is formed in two parts comprising a first socket housing part 2a and a second socket housing part 2b connectable or connected thereto. It should be understood that all statements concerning the socket 1 comprising a one-piece socket housing 2 apply equally to the socket 1 comprising the two-piece socket housing 2, and vice versa. The socket wall 5 defines a likewise substantially cylindrical socket opening 9, in which a contact element 6 is receivable. The socket 1 and the contact element 6 are therefore two components formed separately from one another.

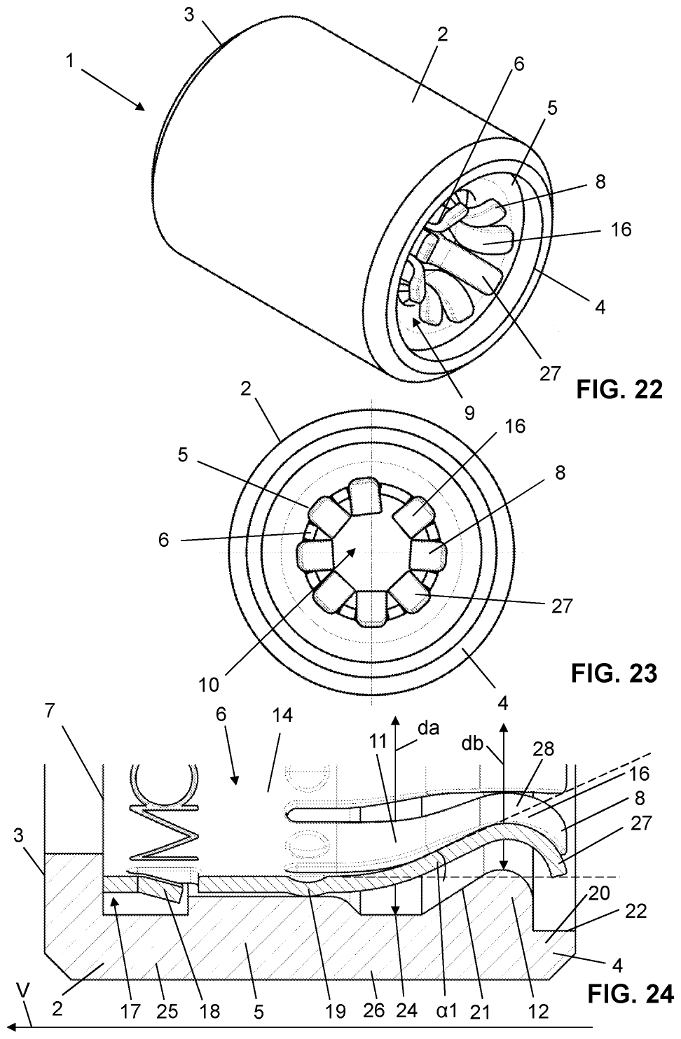

The contact element 6 comprises a proximal contact element end 7, a distal contact element end 8, and a contact region 28 which is designed to form a functional contact, in particular an electrical contact, with the plug. For this purpose, the contact element 6 delimits a contact element opening 10 into which the plug can be accommodated. In addition, the contact element 6 has at least one elastic contact section 11, at least in certain regions, the elastic contact section 11 being designed in such a way that, when the plug is received in the contact element opening 10 of the contact element 6 of the socket 1, it expands radially with respect to a longitudinal direction L extending centrally through the socket 1. In order to prevent the elastic contact section 11 from being bent in the case of an obliquely inserted plug, thereby reducing or even rendering impossible the functional contact between the socket and the plug, the socket wall 5 has, on the inside, a limiting element 12 which is formed in such a way as to limit a radial expansion of the elastic contact section 11 of the contact element 6. Namely, the limiting element 12 is formed such that a plastic deformation of the elastic contact section 11 of the contact element 6 of the socket 1 is prevented when the plug is received in the contact element opening 10 of the contact element 6 of the socket 1, while an elastic deformation is allowed. Therefore, as will be explained in more detail below in connection with FIGS. 22 to 27, the limiting element 12 is arranged in the region of the contact region 28 of the contact element 6. Further, the limiting element 12 is here formed substantially complementary to the elastic contact section 11 of the contact element 6 of the socket 1, at least in some areas. When the plug is received in the contact element opening 10 of the contact element 6, an electrical contact is established between the elastic contact section 11 and the plug. The contact element 6 comprises a plurality of elastic contact sections 11, each of which is provided by elastic spring arms each of which terminates in free ends 27 in the region of the distal contact element end 8. With respect to the longitudinal direction, the free ends 27 are offset radially outwards. The contact element 6 thus corresponds to a so-called contact tulip.

As can be readily seen from FIGS. 1 and 2, the socket opening 9 extends substantially completely through the socket housing 2 and has a plurality of differently configured sections. For example, the socket housing has an initial section 25 in the region of the proximal housing end 3, an end section 20 in the region of the distal housing end 4, and a central section 26 between the proximal housing end and the distal housing end. The end section 20 of the socket opening 9 comprises a radial extension 22 with a diameter d3, which is larger than a diameter d1 of the initial section 25 as well as larger than a diameter d2 of the central section 26. In turn, the diameter d1 of the initial section 25 is larger than the diameter d2 of the central section 26. Further, in the region of the distal contact element end 8, the elastic contact section 11 has an end section 16 extending radially outwardly with respect to the longitudinal direction L, so that, in the case of a plug received in the contact element opening 10, a stop is formed between the end sections of the socket and of the plug 20, 16, which prevents displacement of the contact element 6 with respect to the socket housing 2 along a proximal direction P extending from the distal housing end 4 towards the proximal housing end 3.

The socket wall 5 has one or more recesses 17 on the inside in the region of the proximal housing end 3, that is in the initial section 25, and the contact element 6 has a plurality of projections 18 in the region of the proximal contact element end 7, which projections 18 can be received in the recesses 17. When the projections 18 are received in the recesses 17, a displacement of the contact element 6 relative to the socket housing 2 along a distal direction D extending from the proximal housing end 3 towards the distal housing end 4 is prevented. Or, in other words, the projections 18 and the recesses 17 form a snap or latch connection by which the contact element 6 is retained within the socket opening 9. The contact element 6 has a plurality of radially outwardly projecting contact points 19, which are arranged on the outside of the contact element 6 and can be brought into contact with the inside socket wall 5, in particular establishing an electrical connection between the contact element 6 and the socket wall 5. In particular, the contact points 19 transmit the electrical contact made between the elastic contact section 11 and the plug to the socket.

As already explained at the outset, the limiting element 12 is formed, at least in some regions, substantially complementary to the elastic contact section 11 of the contact element 6 of the socket 1. In the embodiments shown, the limiting element 12 is formed, as seen in cross-section with respect to the socket wall 5, at least in some regions as an elevation, and the elastic contact section 11 delimits, as seen in cross-section, at least in some regions a recess 13, the elevation 12 and the recess 13 being formed substantially complementary to one another. Namely, in the case of a plug received in the contact element opening 10, the limiting element 12 or the elevation 12 is substantially received at least regionally in the recess 13 of the elastic contact section 11.

By comparing FIGS. 1 and 2, it can be seen that the elastic contact section 11 is increasingly biased inwardly in the direction of the longitudinal direction L, at least in some regions, starting from the proximal contact element end 7 as viewed towards the distal contact element end 8, while the limiting element 12 is increasingly biased inwardly in the direction of the longitudinal direction L, at least in some regions, starting from the proximal housing end 3 as viewed towards the distal housing end 4. In the absence of a plug, the inwardly biased elastic contact section 11 is radially spaced from the inner-side socket wall 5 as well as from the limiting element 12, see FIG. 1. If the plug is inserted into the contact element opening 10, this presses the elastic contact section 11 radially outwards, whereby the elastic contact section 11 comes to rest on the socket wall 5 and, in the event that the plug is not inserted coaxially but, for example, obliquely into the contact element opening 10, on the limiting element 12, see FIG. 2. The limiting element 12 thereby extends, seen along the longitudinal direction L, at least partially along the elastic contact section 11 of the contact element 6.

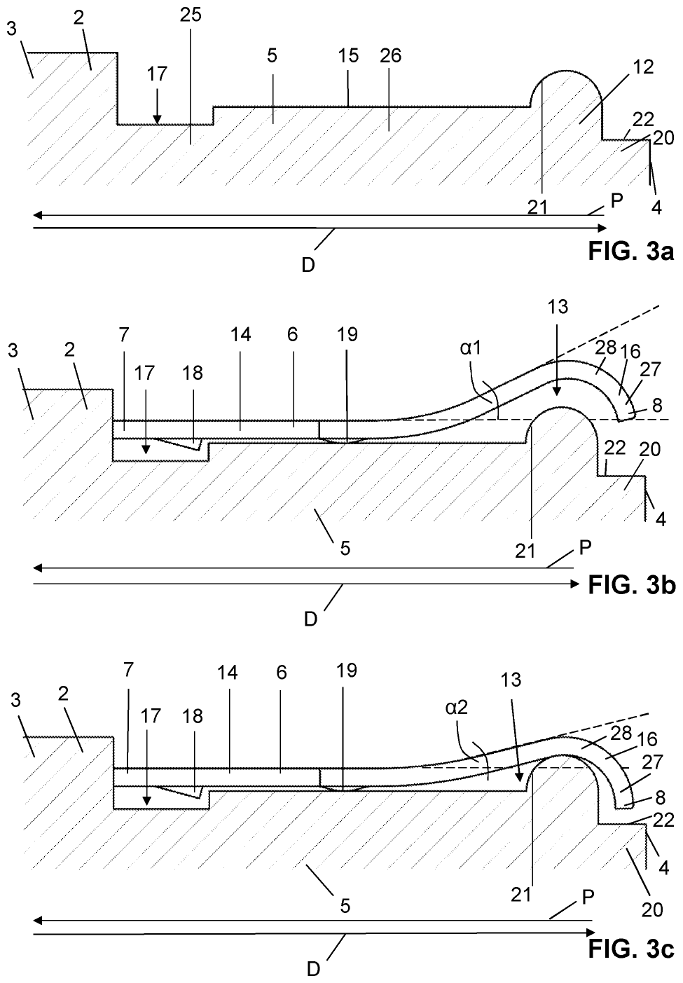

With reference to FIGS. 3a to 3c, this process will now be described in detail. It should be noted that the socket 1 is shown in simplified form in these figures and is primarily intended to serve as an explanation of the principle of operation. In all FIGS. 3a to 3c, a socket housing 2 is shown in each case, which has the said recesses 17 in the initial section 25 and, viewed in the distal direction D, a limiting element 12 projecting inwards in certain regions. The limiting element 12 is formed here in the central section 26 as well as immediately adjacent to the end section 20, and has a substantially semicircular shape as seen in longitudinal section. In FIG. 3b, the socket housing 2 and a contact element 6 received therein are shown with no plug yet inserted into the contact element opening. In this condition, the inwardly biased elastic contact section 11 is spaced from the limiting element 12. The protrusions 18 of the contact element 6 in the region of the proximal contact element end 7 are received in the recesses 17 in the initial section 25 of the socket housing 2, thereby preventing displacement of the contact element 6 along the distal direction D. The inwardly biased elastic contact section 11 and a non-inwardly biased portion 14 of the contact element 6 enclose an angle α1 of about 25°. In FIG. 3c, the socket 1 is shown after a plug (not shown) has been inserted into the contact element opening 10 of the contact element 6, thereby radially expanding the elastic contact section 11 with respect to the longitudinal direction L. The elastic contact section 11 has been radially expanded by the plug (not shown). The elastic contact section 11 has thereby been pushed outwardly with respect to the longitudinal direction L, and strikes against the limiting element 12. Or, in other words, in this state the elastic contact section 11 comes into surface contact with the limiting element 12, at least in some areas. An angle α2 between the inwardly biased elastic contact section 11 and the non-inwardly biased area 14 of the contact element 6 of the socket 1 is here about 10°. Unlike the example according to FIGS. 1 and 2, here the radially outwardly extending end section 16 and the free ends 27 of the spring arms 11 are not in surface contact with the inwardly facing socket housing 5, but are instead spaced therefrom.

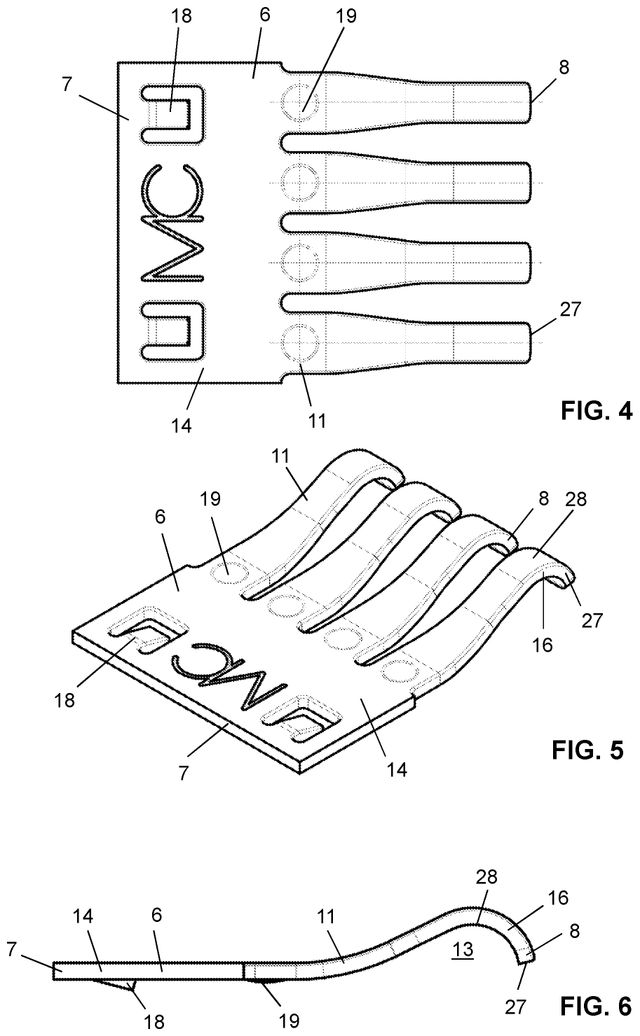

As can be seen from FIGS. 4 to 6, the contact element 6 may be made from an initially flat conductive material. In this flat element of conductive material, recesses defining the protrusions 18 are created by punching in the proximal contact element end 7. Further, the flat element is cut starting from the distal contact element end 8 in the direction of the proximal contact element end 7 such that the spring arms 11 are formed. In addition, the circular contact points 19 are formed at the free ends 27 opposite ends of the spring arms 11 by forming. The initially flat free ends 27 are also formed by forming from a plane extending through the flat element, thereby forming the radially outwardly extending end sections 16. Next, the contact element is rolled up in a rolling process so that the contact element opening 10 is formed. In this way, a plurality of different contact elements can be produced which differ, for example, in their length and/or in their diameter and/or in the radius of curvature of the spring arms 11.

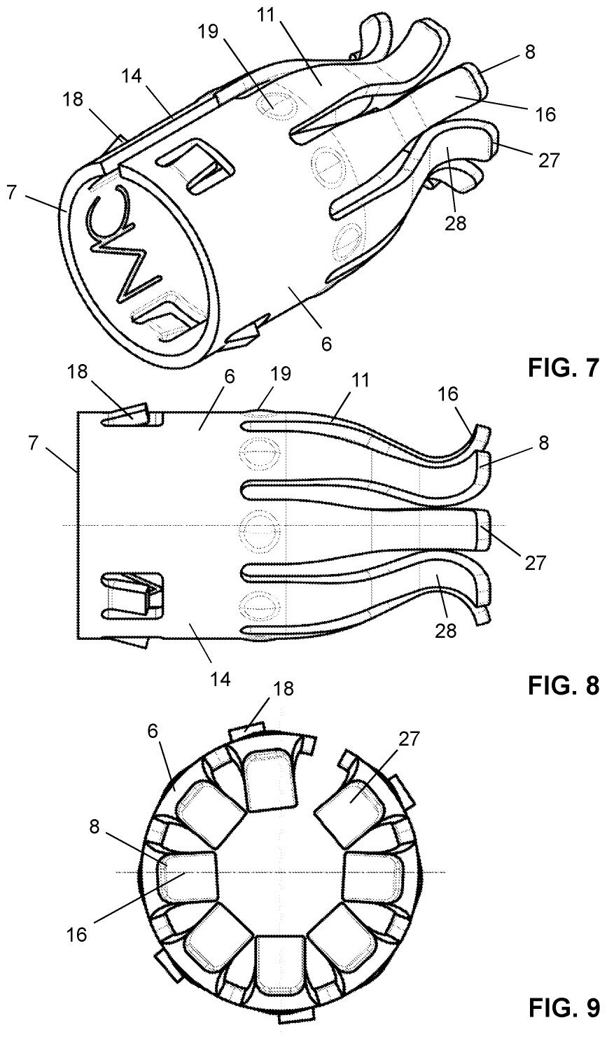

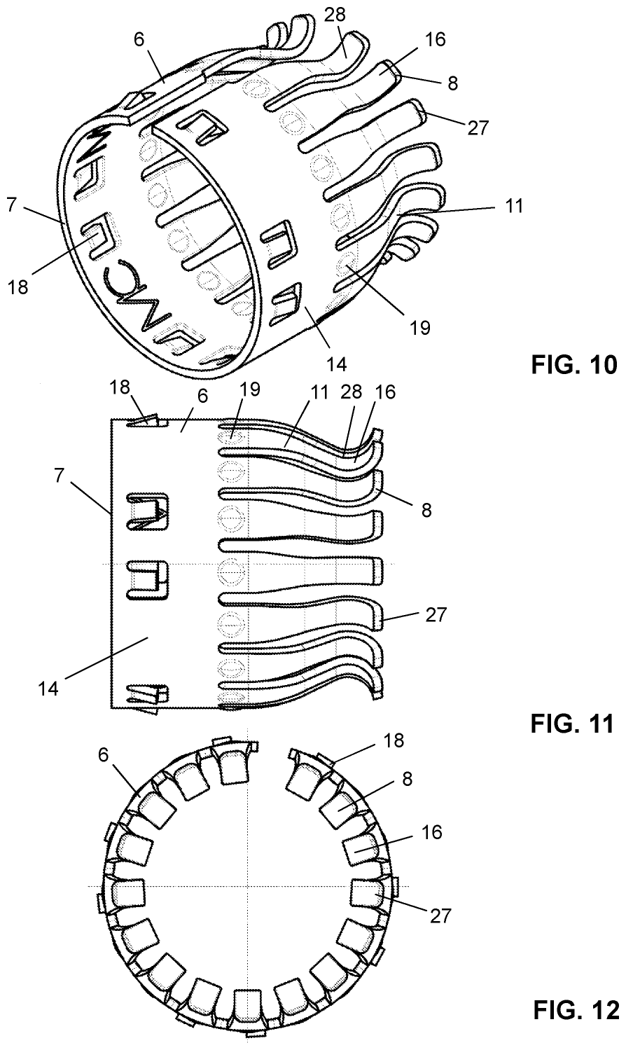

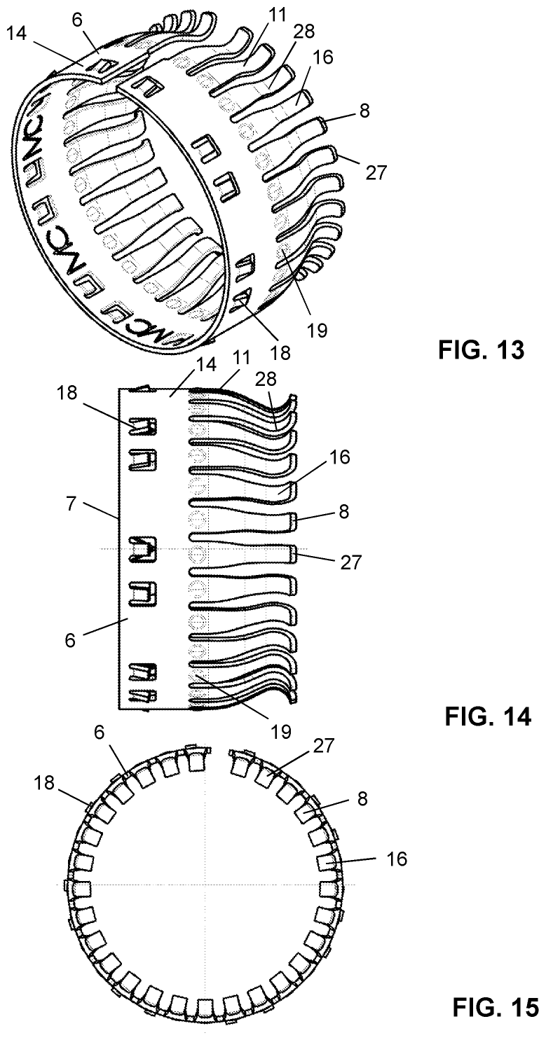

FIGS. 7 to 9, 10 to 12 and 13 to 15 show examples of various contact elements 6. Thus, the contact element according to FIGS. 7 to 9 has an elongated, substantially cylindrical shape. As can be seen in particular from FIG. 9, this contact element comprises a total of eight spring arms as well as four projections. The contact element 6 according to FIGS. 10 to 12 also has an approximately cylindrical shape, but differs from that of FIGS. 7 to 9 in particular by its larger diameter and the greater number of spring arms 11 and projections 18. The contact element 6 according to FIGS. 13 to 15, on the other hand, is substantially annular in shape and has more spring arms 11 and projections 18 than the contact elements according to FIGS. 7 to 12. However, all contact elements 6 have in common that the spring arms 11 are biased inwardly in the rolled-up state and terminate in free ends 27 via radially outwardly extending end sections 16, as well as that a contact point 19 is formed on each spring arm 11 and projections 18 are formed in the region of the proximal contact element end 7. It is thus to be understood that any number of different contact elements are conceivable, each of which differs in its dimensions, such as size or shape, but which nevertheless possess the aforementioned elements and can therefore be used as a contact element in the sense of the invention.

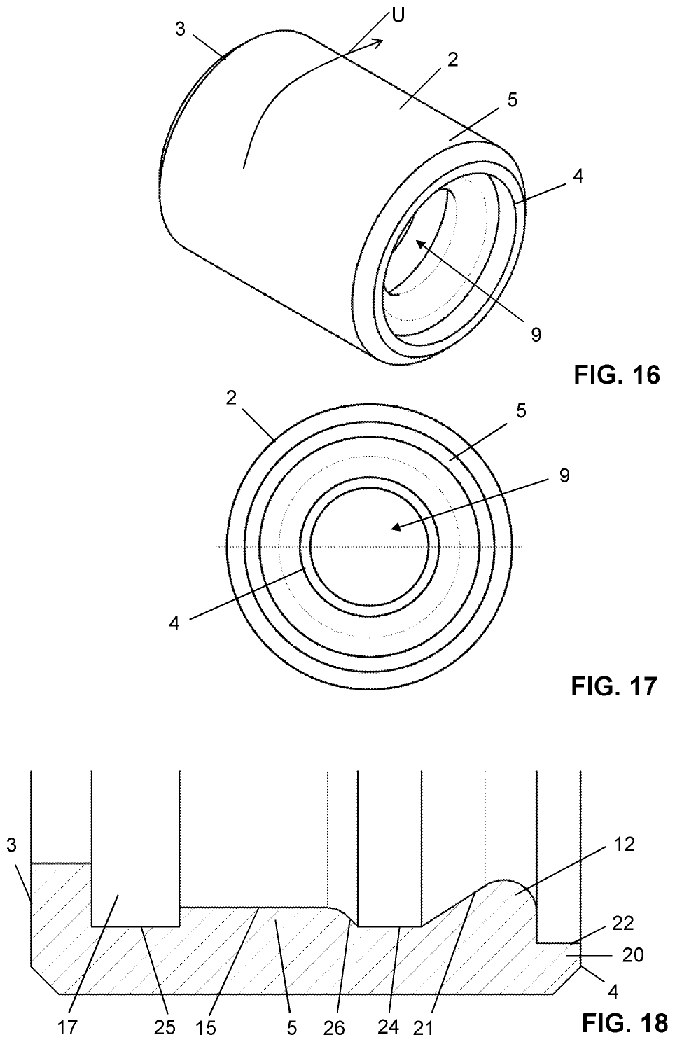

The socket housing 2 can also be provided in different configurations. For example, as can be seen in FIGS. 16 to 18, the socket housing 2 can be provided with a circumferential cylindrical socket wall 5. By milling or drilling, the socket opening 9 projecting completely through the socket housing 2 is produced. As can be seen from FIG. 18, the recess 17 for the projections 18 of the contact element 6 in the initial section 25, the limiting element 12 in the central section 26 and the radial extension 22 in the end section 20 can then be produced on the inside of the socket wall 5. The limiting element 12 according to FIGS. 16 to 18 differs from the limiting element 12 according to FIGS. 1 and 2 by a proximal recess 24 as well as a larger slope, at which the limiting element 12 extends inwards in the direction of the longitudinal axis.

The socket housing 2 according to FIGS. 19 to 21 has been formed by stamping and bending and, like the socket housings 2 of the other examples, comprises a socket wall 5 having a recess 17 in the initial section 25, followed by a central section 26 having a non-inwardly extending region which terminates distally in a first recess 23 and, following this first recess 23, in a second recess 24. The second recess 24 in turn terminates distally into the inwardly extending region 21 of the limiting element 12, which terminates in the end section 20 into the radial extension 22. Again, it is to be understood that any number of different socket housings are conceivable which differ in their dimensions, such as size or shape, but which nevertheless have in particular the limiting element 12 and for example also the recesses 17 as well as the radial extension 22 and can therefore be used as socket housings in the sense of the invention.

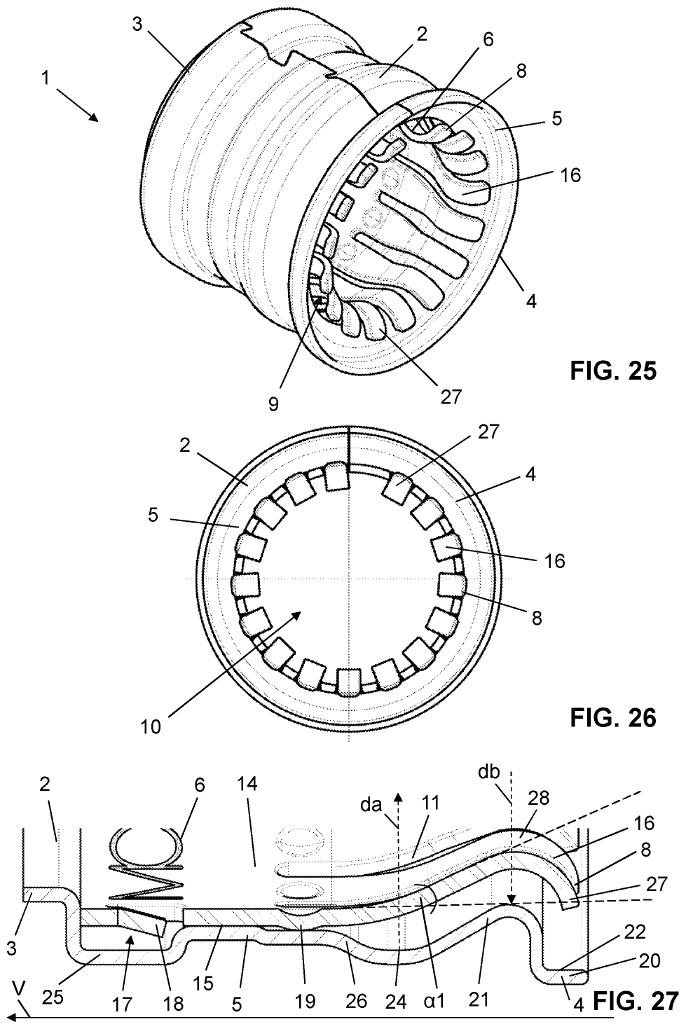

FIGS. 22 to 24 show different views of a socket 1 comprising a contact element 6 according to FIGS. 7 to 9, which has been inserted into the socket opening 9 of a socket housing 2 according to FIGS. 16 to 18. In each of FIGS. 25 to 27, a socket 1 is shown in which a contact element 6 according to FIGS. 10 to 12 has been inserted into a socket housing 2 according to FIGS. 19 to 21. That is, and as can be seen in particular from FIGS. 24 and 27, the contact element 6 comprises in the region of the distal contact element end 8 a contact region 28 which is designed to form a functional contact with a plug inserted into the contact element opening 10. This contact region 28 is formed in the elastic contact section 11, that is, in this case, in the spring arm, thereby forming the point of maximum elevation of the spring arm 11. Or, in other words, the contact region 28 is formed at the point where the elastic contact section 11 is maximally biased inwardly in the direction of the longitudinal direction L, starting from the proximal contact element end 7 as viewed in the direction of the distal contact element end 8. Or again in other words, a diameter of the contact element opening 10 at the location of the contact region 28 is minimal. The inwardly biased elastic contact section 11 and the non-inwardly biased portion 14 of the contact element 6 enclose here a first angle α1 of about 11°. The limiting element 12 is arranged in the region of the contact region 28 of the contact element 6. Namely, starting from the proximal housing end 3 and viewed in the direction of the distal housing end 4, the limiting element 12 increasingly extends inwardly in the direction of the longitudinal direction L, at least regionally, the limiting element 12 being maximally advanced inwardly at the location of the contact region 28. Accordingly, a diameter db of the socket opening 9 at the location of the contact region 28 is also minimal. As can be readily seen from these figures, the limiting element 12 is arranged in the region of the distal end 4 of the housing and, by virtue of this distal arrangement and its inwardly projecting configuration, provides a guide for the plug when it is received in the contact element opening 10 along a connection direction V. Viewed along the proximal direction P, the limiting element 12 opens into the recess 24. Consequently, the socket opening 9 has a larger diameter da in the region of the recess 24 than in the region of the limiting element 12. If a plug is now inserted into the contact element opening 10 of the contact element 6, the elastic contact section 11 of the contact element 6 bends, whereby a part of the elastic contact section 11 is pressed into the recess 24 of the socket 1. In this case, the configuration of the recess 24 is such that the part of the elastic contact section 11 thus bent is elastically deformed, but not plastically deformed, and does not contact the socket wall 21 in the process. Also in the examples shown here, the contact points 19 projecting from the contact element 6 are arranged in the elastic contact section 11, more precisely at the proximal end of the spring arms 11, and act as a pivot point for the spring arms 11 during radial expansion thereof when a plug is received in the contact element opening 10. It is further apparent from these views that the spring arms 11 of the contact elements 6 each extend substantially fully along a circumferential direction U of the socket opening. Also, the recesses 17 as well as the limiting element 12 each extend substantially completely along the circumferential direction U, so that a displacement of the contact element 6 relative to the socket housing 2 due to the engagement between the protrusions 18 and the recesses 17, the forwarding of the electrical contact via the contact points 19 of the contact element 6 to the socket housing 2, and above all a prevention of a plastic deformation of the spring arms 11 when the plug is inserted into the socket 1 is ensured over the entire circumference U of the socket 1.

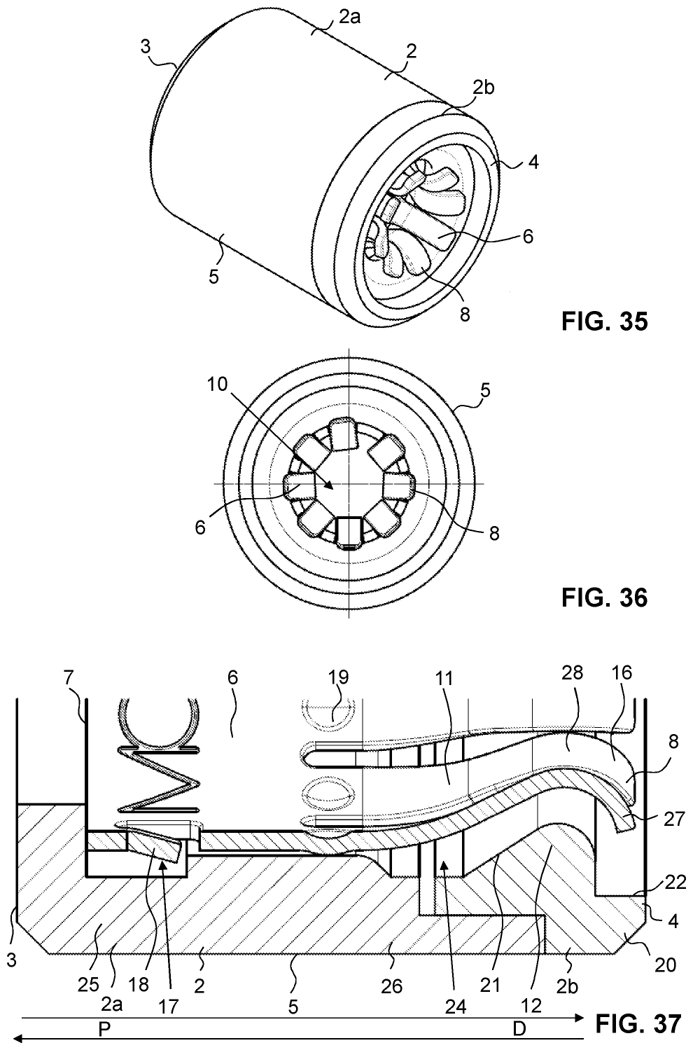

As mentioned at the outset, the socket housing 2 may be formed in several parts, in particular in two parts. Such an embodiment is illustrated in FIGS. 28 to 37. Thus, a two-part or multi-part socket housing 2 enables a simplified insertion of the contact element 6 in the case of a socket 1 or a contact element 6 with a small diameter, respectively. Thus, as can be well seen in these figures, the socket 1 can be formed by a first socket housing part 2a and a second socket housing part 2b which are connectable to each other and form the socket housing 2 when connected. The connection between the two socket housing parts 2a, 2b may be formed in a releasable or non-releasable manner. For example, a connection can be achieved by a force fit and/or a form fit and/or by pressing, gluing, welding, etc. of the two socket housing parts 2a, 2b. FIGS. 30, 34 and 37 show that for this purpose the first socket housing part 2a has a first connecting element 30 in a distal housing part region 29 and the second socket housing part 2b has a second connecting element 32 in a proximal housing part region 31. A connection of the two socket housing parts 2a, 2b is effected via the two connecting elements 30, 32. In the present example, the second socket housing part 2b is at least partially inserted into the first socket housing part 2a to form the socket 1. In a sense, therefore, this is a plug-in connection. For this purpose, the first connecting element 30 is formed as a recess in the inner-side socket wall 5. The second connecting element 32, in turn, also comprises a recess, but in the outside socket wall 5. The recesses 30, 32 are in each case bounded by a surface 33, 34, these surfaces 33, 34 coming to lie flat on one another in the connected state of the socket housing parts 2a, 2b. Further, the distal end 35 of the first connecting element 30 forms a stop for the second connecting element 32, the stop limiting a displacement of the second housing part 2b into the first housing part 2a along the proximal direction P. Further, in the present example, a gap or gslot 36 is formed between the two housing parts 2a, 2b in the connected state. However, except for its two-part configuration, the socket 1 according to FIGS. 28 to 37 does not differ substantially from the socket 1 according to the previous figures. This is particularly evident from FIGS. 35 to 37, which show the two-part socket 1 with the contact element 6 accommodated therein. The contact element 6 here is the contact element 6 according to FIGS. 7 to 9, for which reason reference is made to the above explanations. If the socket 1 has been formed from the socket housing parts 2a, 2b, the contact element 6 can be inserted into the socket opening 9 along the proximal direction P. The socket housing parts 2a, 2b can be inserted into the socket opening 9 along the proximal direction P. In the inserted state, the projections 18 of the contact element 6 engage with the recesses 17 of the initial section 25 of the socket 1, here with the recesses 17 of the initial section 25 of the first socket housing part 2a, and the contact points 19 of the contact element 6 can be brought into contact with the inner-side socket wall 5 of the socket 1, here again with the inner-side socket wall 5 of the first socket housing part 2a. The limiting element 12 is formed here in the second socket housing part 2b. If a plug is now inserted into the contact element opening 10, the latter presses the elastic contact section 11 of the contact element 6 radially outwards so that the latter comes to rest on the socket wall 5 and, in the event that the plug is not inserted coaxially, on the limiting element 12, as explained earlier. In other words, the two-part socket 1 thus also comprises a limiting element 12 for limiting the radial expansion of the elastic contact section 11 of a contact element 6, as well as other elements as described above. Thus, for further explanations, reference is again made to the above statements. The sequence of the individual assembly steps may be different. For example, it is possible to insert the contact element 6 into the first socket housing part 2a in a first step, and then to connect the second socket housing part 2b to the first socket housing part 2a in a second step. However, it is equally conceivable to insert the contact element 6 into the second socket housing part 2b in a first step, and then connect the first socket housing part 2a to the second socket housing part 2b in a second step.

LIST OF REFERENCE SIGNS

| | |
|---|---|
| 1 | socket |
| 2 | socket housing |
| 2a | socket housing part |
| 2b | socket housing part |
| 3 | proximal end of housing |
| 4 | distal end of housing |
| 5 | socket wall |
| 6 | contact element |
| 7 | proximal contact element end |
| 8 | distal contact element end |
| 9 | socket opening |
| 10 | contact element opening |
| 11 | elastic contact section |
| 12 | limiting element |
| 13 | recess |
| 14 | portion |
| 15 | portion |
| 16 | end section |
| 17 | recess |
| 18 | protrusions |
| 19 | contact point |
| 20 | end section |
| 21 | region |
| 22 | radial extension |
| 23 | recess |
| 24 | recess |
| 25 | initial section |
| 26 | central section |
| 27 | free end |
| 28 | contact region |
| 29 | distal housing region |
| 30 | connecting element |
| 31 | proximal housing region |
| 32 | connecting element |
| 33 | surface |
| 34 | surface |
| 35 | distal end |
| 36 | gap |
| L | longitudinal direction |
| D | distal direction |
| P | proximal direction |
| U | circumferential direction |
| α1 | angle |
| α2 | angle |
| d1 | diameter |
| d2 | diameter |
| d3 | diameter |
| da | diameter |
| db | diameter |

1. A socket for connecting to a plug comprising:
a socket housing having a proximal housing end, a distal housing end and a socket wall, and
a contact element having a proximal contact element end and a distal contact element end,
wherein the socket wall delimits a socket opening in which the contact element can be received,
wherein the contact element has a contact region which is designed to form a functional contact with the plug,
wherein the contact element delimits a contact element opening into which the plug can be received, and
wherein the contact element has at least regionally at least one elastic contact section, wherein the elastic contact section is formed in such a way that, when the plug is received in the contact element opening of the contact element of the socket, it expands radially with respect to a longitudinal direction extending centrally through the socket, and
wherein the socket wall has on the inside a limiting element which is designed in such a way that a radial expansion of the elastic contact section of the contact element is limited.

2. The socket according to claim 1, wherein the limiting element is designed in such a way that plastic deformation of the elastic contact section of the contact element of the socket is prevented when the plug is received in the contact element opening of the contact element of the socket.

3. The socket according to claim 1, wherein the limiting element is arranged and formed to provide a guide for the plug when it is received in the contact element opening along a connection direction.

4. The socket according to claim 1, wherein the limiting element is arranged in the region of the distal housing end.

5. The socket according to claim 1, wherein the limiting element is formed at least regionally substantially complementary to the elastic contact section of the contact element of the socket.

6. The socket according to claim 17, wherein, in the case of a plug received in the contact element opening, the elevation is substantially completely receivable in the recess of the elastic contact section.

7. The socket according to claim 1, wherein at least one of:
i) the elastic contact section, starting from the proximal contact element end as seen in the direction of the distal contact element end, is increasingly biased inwards in the direction of the longitudinal direction at least in regions, and
ii) starting from the proximal housing end and viewed in the direction of the distal housing end, the limiting element extends inwards at least in regions in the direction of the longitudinal direction.

8. The socket according to claim 7, wherein at least one of:
i) the inwardly biased elastic contact section and a non-inwardly biased region of the contact element of the socket in the absence of the plug in the contact element opening enclose a first angle of about 10° to 50° or of about 15° to 45° or of about 20° to 40°, and
ii) the inwardly biased elastic contact section and the non-inwardly biased region of the contact element of the socket enclose a second angle of from about 5° to 45° or from about 5° to 40° or from about 5° to 35°, in the case of a plug being received in the contact element opening.

9. The socket according to claim 1, wherein a diameter of the socket opening in the region of the limiting element is smaller than a diameter in a region of the socket opening adjoining this region and facing the proximal housing end.

10. The socket according to claim 1, wherein the limiting element extends at least partially along a circumferential direction of the socket wall.

11. The socket according to claim 1, wherein the socket wall has one or more recesses in the region of the proximal housing end, and wherein the contact element has one or more projections in the region of the proximal contact element end, which can be accommodated in the recesses, as a result of which displacement of the contact element with respect to the socket housing along a distal direction running from the proximal housing end in the direction of the distal housing end is prevented.

12. The socket according to claim 1,
wherein the contact element has one or more contact points projecting radially outwards that are arranged on the outside of the contact element and can be brought into contact with the inside socket wall, and
wherein a connection between the contact element and the socket wall can be established.

13. The socket according to claim 1, wherein the elastic contact section is provided by two or more elastic spring arms, each of which terminates in free ends in the region of the distal contact element end.

14. A plug connector comprising a socket according to claim 1 and a plug,
wherein the plug is received in the contact element opening of the contact element of the socket and radially expands the elastic contact section with respect to the longitudinal direction, and
wherein the radial expansion of the elastic contact section is limited by the limiting element.

15. Method of manufacturing a socket for connecting to a plug comprising the steps:
providing a socket housing having a socket wall, the socket wall delimiting a socket opening;
providing a contact element; and
inserting the contact element into the socket opening,
the contact element having a contact region which is designed to form a functional contact with the plug, the contact element delimiting a contact element opening into which the plug can be received, and the contact element having, at least in regions, at least one elastic contact section, and
the elastic contact section being designed in such a manner that, when the plug is received in the contact element opening of the contact element of the socket, it expands radially with respect to a longitudinal direction extending centrally through the socket, the socket wall having on the inside a limiting element which is designed in such a way that a radial expansion of the elastic contact section of the contact element is limited.

16. The socket according to claim 1, wherein the limiting element is arranged in the region of the contact region of the contact element.

17. The socket according to claim 5,
wherein the limiting element, viewed in cross-section with respect to the socket wall, is formed at least regionally as at least one elevation and the elastic contact section, viewed in cross-section, delimits at least regionally at least one recess, and
wherein the elevation and the recess are formed substantially complementary to each other.

18. The socket according to claim 7, wherein the limiting element extends inwards at least in regions and increasingly in the direction of the longitudinal direction.

19. The socket according to claim 13, wherein the free ends are offset radially outwards with respect to the longitudinal direction.

20. The method according to claim 15, wherein the limiting element is arranged in the region of the contact region of the contact element.
